(19) United States
(12) Patent Application Publication
(10) Pub. No.: US 2004/0268362 A1
(43) Pub. Date: Dec. 30, 2004

(54) Method, apparatus and program storage device for providing a two-step communication scheme

(75) Inventors: David Darden Chambliss, Morgan Hill, CA (US); Divyesh Jadav, San Jose, CA (US); Tzongyu Paul Lee, Campbell, CA (US); Ramachandran Gopalakrishna Menon, Sunnyvale, CA (US); Prashant Pandey, Fremont, CA (US); Jian Xu, San Jose, CA (US)

Correspondence Address: Crawford Maunu PLLC, Suite 390, 1270 Northland Drive, St. Paul, MN, 55120, US

(73) Assignee: International Business Machines Corporation

(21) Appl. No.: 10/603,327

(22) Filed: Jun. 25, 2003

(51) Int. Cl. G06F 9/46

(52) U.S. Cl. 719/312

(57) ABSTRACT

The present invention discloses a method, apparatus and program storage device for providing a two-step communication scheme. According to the present invention, a scalable mailbox paradigm that can be used by two processes as a communication tool in a non-blocking manner is provided.

### BACKGROUND OF THE INVENTION

1. Field of the Invention

This invention relates in general to inter-process communication, and more particularly to a method, apparatus and program storage device for providing a two-step communication scheme.

2. Description of Related Art

Today business and personal activities generate an astonishing amount of electronic information that must be managed. Such management involves transmitting, receiving, processing, and storing electronic data. Data processing systems (systems) with multiple input/output (I/O) storage subsystems have been developed to manage this large volume of data. Data processing systems (systems) with multiple input/output (I/O) storage subsystems generally have multiple independent communication paths between at least one processor and each storage system. A typical data processing system includes clients that have an application program and an operating system. Further, in a typical data processing system, clients request data that is stored in various types of storage devices via at least one storage controller. High availability is provided by redundancy of the storage subsystems, multiple I/O channels, multiple controller paths in the storage controller, and multiple communication links between the storage controller and the storage devices. However, such system designs cannot guarantee delivery of data at service levels specified using service level agreements.

The concept of service level agreements has created a demand for accountability that transcends enterprise and service provider environments. A Service Level Agreement (SLA) is a contract between a network service provider and a customer that specifies, usually in measurable terms, what services the network service provider will furnish. For example, IT departments in major enterprises have adopted the idea of writing a Service Level Agreement so that services for their customers (users in other departments within the enterprise) can be measured, justified, and perhaps compared with those of outsourcing network providers. These concepts are applicable to the storage system environment.

Nevertheless, service providers must prove the value of services being delivered, particularly in light of the fact that these services are often obtained at a premium price. Companies are investing hundreds of billions of dollars in technology in order to become even more competitive. To stay in business, a company's ability to transact business cannot be impeded because a database server is out of disk space. As soon as a piece of the IT infrastructure fails, critical business operations begin to suffer; so, it is crucial that IT organizations keep these indispensable operations functioning.

Accordingly, storage can't be an afterthought anymore because too much is at stake. Two new trends in storage are helping to drive new investments. First, companies are searching for more ways to efficiently manage expanding volumes of data and make that data accessible throughout the enterprise—this is propelling the move of storage into the network. Second, the increasing complexity of managing large numbers of storage devices and vast amounts of data is driving greater business value into software and services.

These factors are the drivers for the development of Storage Area Networks (SANs). A SAN consists of a communication infrastructure, which provides physical connections; and a management layer, which organizes the connections, storage elements, and computer systems so that data transfer is secure and robust. The term SAN is usually (but not necessarily) identified with block I/O services rather than file access services. It can also be a storage system consisting of storage elements, storage devices, computer systems, and/or appliances, plus all control software, communicating over a network. Thus, a SAN is a high-speed network that allows the establishment of direct connections between storage devices and processors (servers) within the distance supported by a high-speed data link such as Fibre Channel. The SAN can be viewed as an extension to the storage bus concept, which enables storage devices and servers to be interconnected using similar elements as in local area networks (LANs) and wide area networks (WANs): routers, hubs, etc. SANs offer simplified storage management, scalability, flexibility, availability, and improved data access, movement, and backup.

To provide quality-of-service guarantees over a SAN, priority access must be given to the programs that need a fast response time. Without service level agreements, low-priority jobs would be allowed to take up a storage system's time when those jobs could be postponed a few fractions of a second.

A centralized server is used to provide SLA in a SAN infrastructure. The centralized server accumulates SLAs on storage performance commitments and produces real-time monitoring display on clients. This centralized server is referred to as a SLA server. The SLA server connects to multiple I/O service agents that reside in separate virtualization engines (processors) placed between application hosts and storage subsystems. Such agents are called performance gateways. An I/O performance gateway is disposed between multiple application hosts and multiple physical storage subsystems. The I/O performance gateways intercept I/O operations, send statistic data to the SLA server and take requests from the SLA server to throttle I/O operations when necessary. In such an environment, a reasonable large number of application hosts commonly share multiple storage subsystems.

The control system needs to control multiple gateways concurrently by quickly accessing the SLA database and analyzing the data against SLAs and policies in a parallel manner. The monitoring and throttling of block I/O operations is provided by inter-process communications. If the message passing from the SLA server to multiple I/O service agents becomes a bottleneck, the system will fail to satisfy the SLAs and therefore fail in its mission.

It can be seen that there is a need for a method, apparatus and program storage device for providing an improved communication scheme.

### SUMMARY OF THE INVENTION

To overcome the limitations in the prior art described above, and to overcome other limitations that will become apparent upon reading and understanding the present specification, the present invention discloses a method, apparatus and program storage device for providing a two-step communication scheme.

The present invention solves the above-described problems by providing a scalable mailbox paradigm that can be used by two processes as a communication tool in a non-blocking manner.

A program storage device readable by a computer tangibly embodying one or more programs of instructions executable by the computer to perform a method for providing a two-step communication scheme is provided in accordance one embodiment of the present invention. The method of the program storage device includes establishing for a first process exclusive access to a mailslot in a mailbox shared by a plurality of processes and accessing the mailslot by the first process to modify the contents of the mailslot to facilitate inter-process communication.

In another embodiment of the present invention, a mailbox for use in a two-step communication scheme is provided. The mailbox includes a shared memory configured for establishing at least one mailslot, access to a mailslot being granted exclusively to a first process for modification of contents of the mailslot to facilitate inter-process communication.

In another embodiment of the present invention, a system is provided. The system includes a first process, a second process, and a mailbox, disposed between the first and second process, the mailbox comprising a shared memory configured for establishing at least one mailslot, access to a mailslot being granted exclusively to the first process for modification of contents of the mailslot to facilitate inter-process communication.

In another embodiment of the present invention, a service level agreement (SLA) server is provided. The SLA server includes a plurality of processes, the plurality of processes comprising a database manager for managing performance data, an application server for collecting performance data and providing a client interface for establishing service level agreements, a SLA core for analyzing data and controlling actions based on service level agreements and policy and a performance monitor daemon for communicating with remote I/O service gateways to collect data and send throttling requests and a shared memory forming a mailbox, the mailbox using a two-step communication scheme between a first process and a second process, the mailbox configured for establishing at least one mailslot, access to a mailslot being granted exclusively to a first process for modification of contents of the mailslot to facilitate inter-process communication.

In another embodiment of the present invention, another service level agreement (SLA) server is provided. This embodiment of the SLA server includes a processor configured for providing a plurality of processes and memory configured for forming a mailbox, the mailbox being used for a two-step communication scheme between a first process and a second process, wherein the processor establishes at least one mailslot in the mailbox and grants access to a mailslot exclusively to a first process for modification of contents of the mailslot to facilitate inter-process communication.

In another embodiment of the present invention, a method for providing a two-step communication scheme is provided. The method includes establishing for a first process exclusive access to a mailslot in a mailbox shared by a plurality of processes and accessing the mailslot by the first process to modify the contents of the mailslot to facilitate inter-process communication.

In another embodiment of the present invention, another mailbox for providing a two-step communication scheme is provided. This mailbox includes a shared memory means for establishing at least one means for storing mail, access to a means for storing mail being granted exclusively to a first process means for modification of contents of the means for storing mail to facilitate inter-process communication.

In another embodiment of the present invention, another system is provided. This system includes first process means, second process means, mailbox means comprising a shared memory, disposed between the first and second process means, configured for establishing at least one means for storing mail, access to means for storing mail being granted exclusively to the first process means for modification of contents of the means for storing mail to facilitate inter-process communication.

In another embodiment of the present invention, another SLA server is provided. This SLA server includes plurality of process means, the plurality of process means comprising means for managing performance data in a database, application server means for collecting performance data and providing a client interface for establishing service level agreements, means for analyzing data and controlling actions based on service level agreements and policy and a means for communicating with remote I/O service gateways to collect data and send throttling requests and memory means forming a mailbox, the memory means used in a two-step communication scheme between a first process means and a second process means, the memory means configured for establishing at least one means for storing mail, access to means for storing mail being granted exclusively to a first process means for modification of contents of the means for storing mail to facilitate inter-process communication.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage area network according to one embodiment of the present invention;

FIG. 2 illustrates an SLA server according to one embodiment of the present invention;

FIG. 3 illustrates the usage of a mailbox according to one embodiment of the present invention;

FIG. 4 illustrates a number of fixed-size mailslots for a mailbox according to one embodiment of the present invention;

FIG. 5 illustrates a two-step non-blocking communication scheme according to one embodiment of the present invention;

FIG. 6 illustrates a method for providing a two-step communication scheme according to one embodiment of the present invention; and

FIG. 7 illustrates a method for revoking mailslot entries according to one embodiment of the present invention.

### DETAILED DESCRIPTION OF THE INVENTION

In the following description of the exemplary embodiment, reference is made to the accompanying drawings that form a part hereof, and in which is shown by way of illustration the specific embodiment in which the invention may be practiced. It is to be understood that other embodiments may be utilized because structural changes may be made without departing from the scope of the present invention.

The present invention provides a method, apparatus and program storage device for providing a two-step communication scheme. Two processes use a scalable mailbox paradigm as a communication tool in a non-blocking manner.

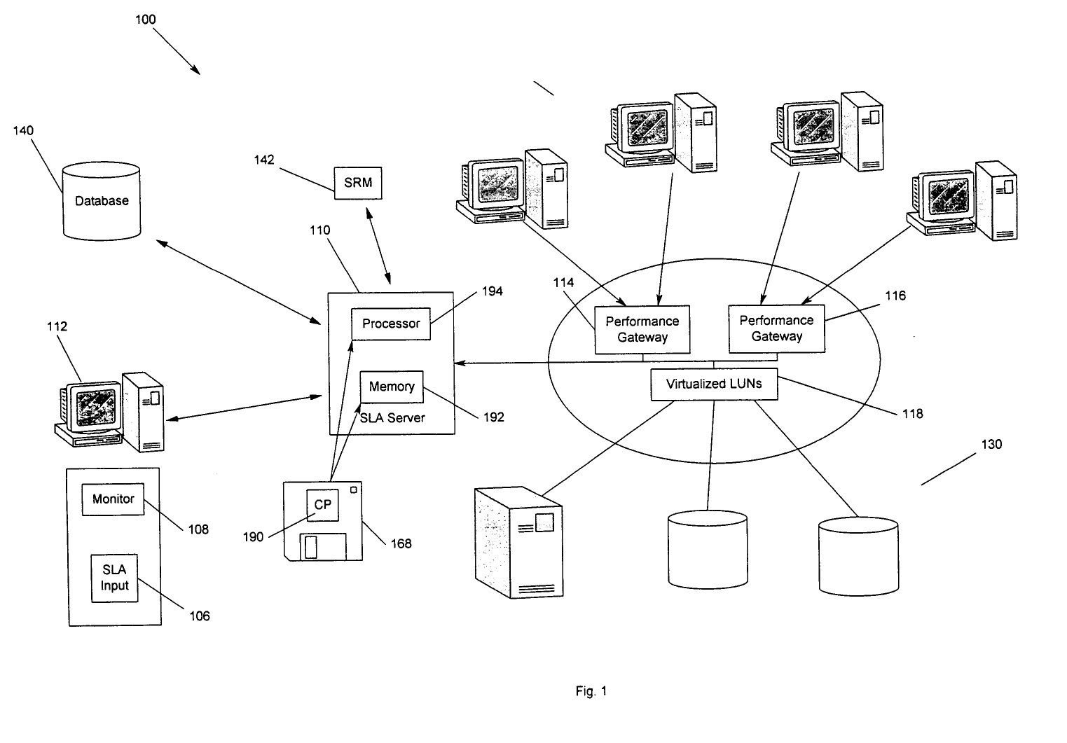

FIG. 1 illustrates a storage area network 100 according to one embodiment of the present invention. In FIG. 1, a Service Level Agreement (SLA) server 110 accumulates SLAs on storage performance commitments from SLA input 106 provided by SLA clients 112 and produces real-time monitoring display 108 on SLA clients. The SLA server 110 connects to multiple I/O performance gateways 114, 116 that reside in separate virtualization engines (processors). The I/O performance gateways 114, 116 are disposed between application hosts 120 and storage subsystems 130. The physical assets of each of the storage subsystems 130 are grouped into virtualized LUNs 118. The I/O performance gateways 114, 116 intercept I/O operations, send statistic data to the SLA server 110 and take requests from the SLA server 110 to throttle I/O operations when necessary. The SLA server 110 controls multiple I/O performance gateways 114, 116 concurrently by accessing the SLA database 140 and analyzing the data against SLAs and policies in a parallel manner. Storage resource manager 142 may be provided to monitor the storage servers 130 for disk space and to provide forecasting tools, alerts and policy-based automation. The monitoring and throttling of block I/O operations is provided by inter-process communications within the SLA server 110 as will be described below.

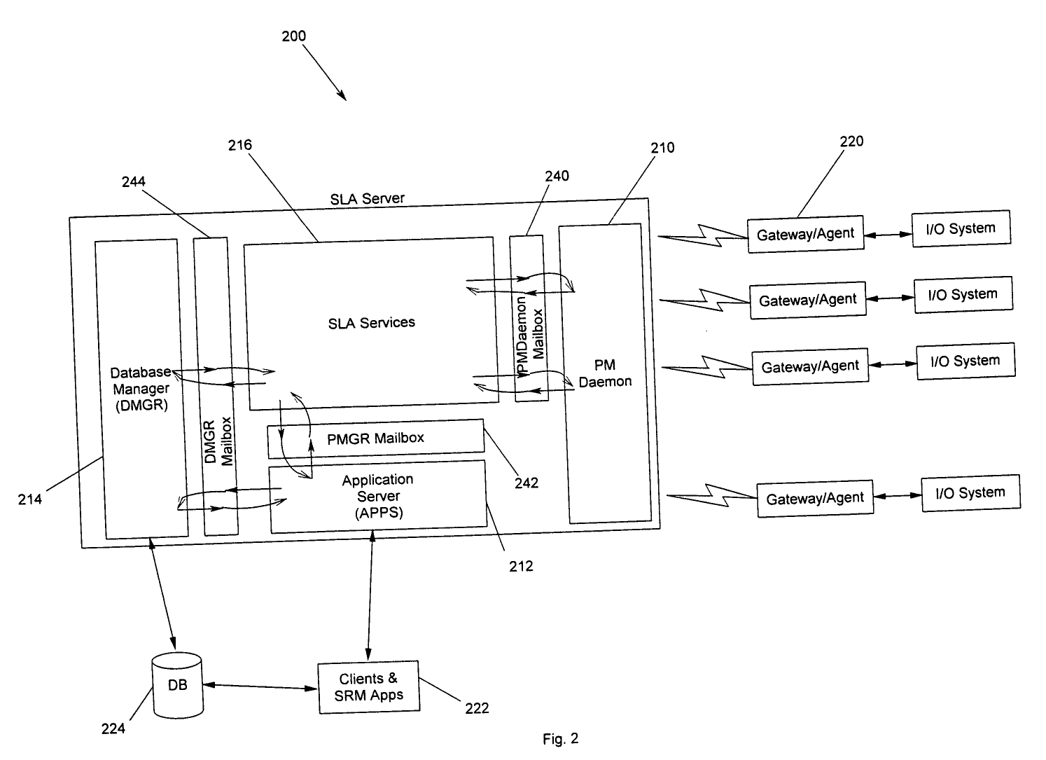

FIG. 2 illustrates the SLA server 200 according to one embodiment of the present invention. In FIG. 2, the SLA server 200 includes four processes to provide SLA control and inter-process communications. The four processes may be provided with separate address space in memory to provide protection from each other. The first process is the performance monitor daemon (PMDaemon) 210. The PMDaemon communicates with remote I/O service gateways 220 to collect data and send throttling requests. The PMDaemon 210 may be multiple threaded to provide parallel communications with multiple gateways 220.

The application server 212 communicates with a web servlet via the clients 222. The web servlet accepts user input and displays monitoring information on web clients 222. To perform these functions, the application server 212 must consistently collect performance data and send client request to SLA services 216. The application server 212 also communicates with a database manager 214.

The database manager 214 keeps multiple connections to the database 224. The database manager 214 retrieves and stores performance data. The SLA service 216 is a core server that analyzes data and controls actions based on service level agreements and policy.

FIG. 2 also shows mailboxes 240, 242, 244 disposed in the SLA server 200 along with the SLA services 216, the database manager 214, the application server 212 and the PMDaemon 210. The mailboxes 240, 242, 244 prevent inter-process communications from becoming a performance bottleneck. The mailboxes 240, 242, 244 provide a non-blocking two-step communication scheme that allows concurrent servicing of multiple I/O requests and database requests.

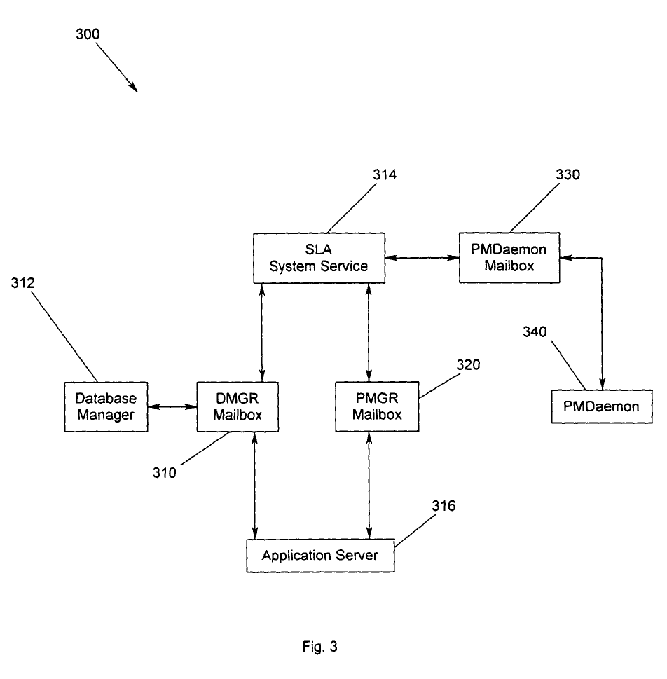

FIG. 3 illustrates the usage of the mailboxes 300 according to one embodiment of the present invention. In FIG. 3, a first mailbox 310 is disposed between the database manager 312 and the SLA services 314. The first mailbox 310 also communicates with the application server 316. A second mailbox 320 is disposed between the SLA services 314 and the application server 316. A third mailbox 330 is provided between the SLA services 314 and the PMDaemon 340.

By preventing performance bottlenecks within the inter-process communications, the mailboxes 310, 320, 330 facilitate scalability of the system. The mailboxes 310, 320, 330 use a two-step remote procedure call (RPC). The first step is a non-blocking call and the second is a notification event at some time later when the required task is completed. The mailboxes 310, 320, 330 share memory space that can be accessed by processes of different progeny.

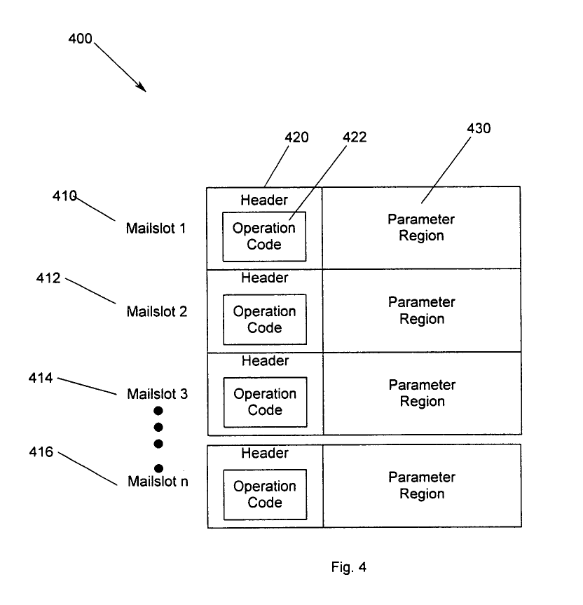

FIG. 4 illustrates a number of fixed-size mailslots 400 for a mailbox according to one embodiment of the present invention. Placing or changing content, such as a message, in a mailslot 410-416, initiates a mailbox call. Each mailslot 414-416 includes a header 420 with an operation code 422. After the header a parameter region 430 is provided. The interpretation of the parameter region 430 is governed by the operation code 422. An additional semaphore may be used to signal a call.

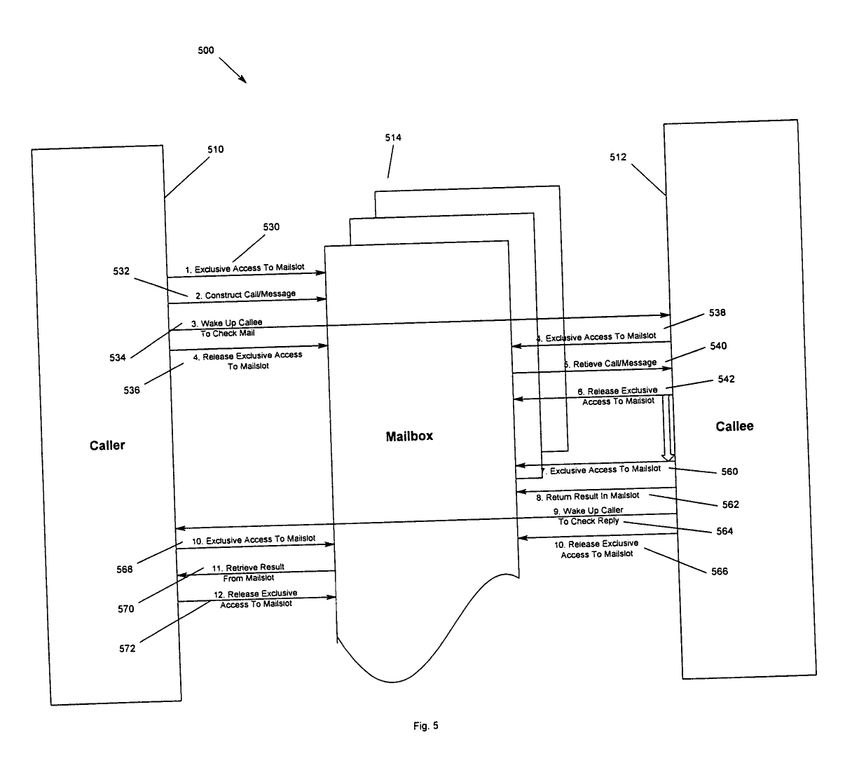

FIG. 5 illustrates two-step non-blocking communication scheme with a mailbox 500 according to one embodiment of the present invention. The process that initiates a mailbox call by placing a message into a mailslot is the caller 510. The other process is the callee 512. The mailbox 514 is modeled on the consumer-producer model. The caller 510 produces the message, and is thus the producer. The callee 512 takes action upon receiving the message and is therefore the consumer. The mailbox 514 can be used by multiple consumers and by multiple producers. However, those skilled in the art will recognize that the present invention is not meant to be limited to such a configuration. For example, the mailbox may be implemented in an environment having one consumer and multiple producers per mailbox. In this configuration, one callee 512 may act on multiple requests from multiple callers 510. However, the reverse is also true.

In FIG. 5, the caller requests exclusive access to a mailslot 530. The caller then constructs a call/message for the mailslot 532. The caller sends a wakeup message to the callee for the callee to check the mailbox 534. The caller then releases the exclusive access to the mailslot 536. The callee requests exclusive access to the mailslot 538. The callee retrieves the call/message from the mailslot 540. The callee releases exclusive access to the mailslot 542 to complete the first stage of the communication scheme.

After the callee has processed the call/message retrieved from the mailslot, the callee again requests exclusive access to the mailslot 560. The callee returns a result to the mailslot 562. The callee sends a wake up to the caller to check the reply 564. The callee then releases exclusive access to the mailslot 566. The caller next requests exclusive access to the mailslot 568. The caller retrieves the result from the mailslot 570 and then releases exclusive access to the mailslot 572.

In FIG. 5, the mailbox is provided using a shared memory segment and semaphore technology. The semaphore object provides the serialization and synchronization. In FIG. 5, the steps of obtaining 530 538, 560, 568 and releasing 536, 542, 566, 572 exclusive access to the mailslots are implemented by using a binary semaphore, while synchronization of waiting and wakeup 534, 564 are implemented by a counting semaphore.

The mailbox therefore provides a non-blocking and scalable architecture for autonomic storage performance control. Mailslots of the mailbox are revocable, i.e., cancellation of a command may be accomplished by modifying the individual mailslot. Because the mailslots serve as the reference block for the RPC transactions, the provider may be shut down and restarted, and upon restart the provider can inspect the mailbox to resume some RPCs. This means that the consumer has less need to be aware of such changes in the provider.

The consumer may also be shut down and resumed. The mailslot contents define the shared memory resources that may be used by the provider to proceed safely while re-establishing synchronization with the provider.

Further, any process may inspect and modify the mailslot contents. This process may be performed to provide a unified monitoring and debugging facility that extends over many provider-consumer pairs. The third party may also use the mailbox behavior to determine when either party should be restarted. Each process within the application may also be periodically shutdown and restarted without disrupting the other processes. Still further, new versions of the components may be more easily staged with a stateful mailbox.

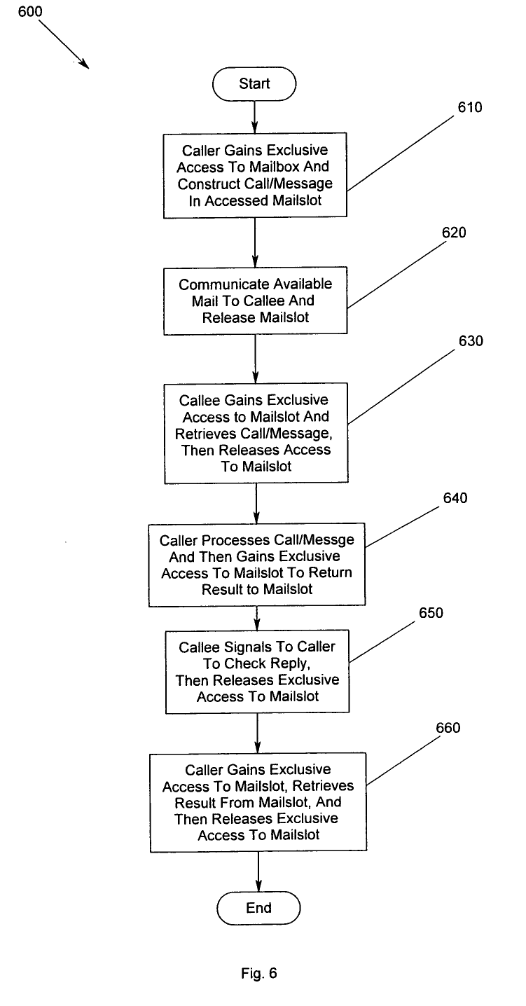

FIG. 6 illustrates a method for providing a two-step communication scheme according to one embodiment of the present invention. The caller requests exclusive access to a mailslot and constructs a call/message to the mailslot 610. The caller then communicates to the callee to check for available mail and releases the exclusive access to the mailslot 620. The callee requests exclusive access to the mailslot, retrieves the call/message from the mailslot, and then releases exclusive access to the mailslot 630.

After the callee has processed the call/message retrieved from the mailslot, the callee again requests exclusive access to the mailslot to return a result to the mailslot 640. The callee signals to the caller to check the reply and then releases exclusive access to the mailslot 650. The caller next requests exclusive access to the mailslot, retrieves the result from the mailslot and then releases exclusive access to the mailslot 660. The non-blocking call and notification event form the two-step communication scheme.

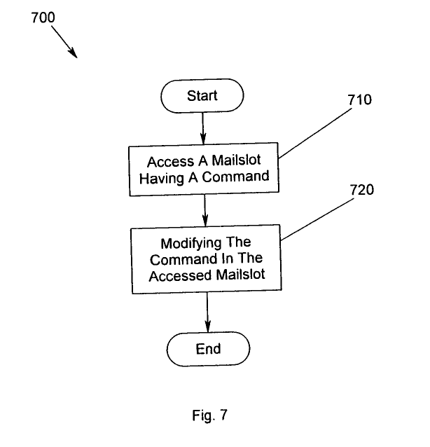

FIG. 7 illustrates a method for revoking mailslot entries according to one embodiment of the present invention. A process gains exclusive access to a mailslot having a command therein 710. The process then modifies the command in the accessed mailslot 720. The command may be modified in any manner, e.g., the command may be changed or the command may be cancelled by modifying the command appropriately.

Returning to FIG. 1, the process illustrated with reference to FIGS. 1-7 may be tangibly embodied in a computer-readable medium or carrier, e.g. one or more of the fixed and/or removable data storage devices 168 illustrated in FIG. 1, or other data storage or data communications devices. A computer program 190 expressing the processes embodied on the removable data storage devices 168 may be loaded into the memory 192 or into the processor 194 of the SLA server 110 to configure the SLA server 110 of FIG. 1 for execution. The computer program 190 comprise instructions which, when read and executed by the SLA server 110 of FIG. 1, causes the SLA server 110 to perform the steps necessary to execute the steps or elements of the present invention

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A program storage device readable by a computer, the medium tangibly embodying one or more programs of instructions executable by the computer to perform a method for providing a two-step communication scheme, the method comprising:
establishing for a first process exclusive access to a mailslot in a mailbox shared by a plurality of processes; and
accessing the mailslot by the first process to modify the contents of the mailslot to facilitate inter-process communication.

2. The program storage device of claim 1 wherein the mailslot comprises header having an operation code and a parameter region interpreted according to the operation code.

3. The program storage device of claim 1 wherein the first process comprises a caller and wherein the accessing the mailslot by the first process to modify the contents of the mailslot further comprises placing content into the mailslot by a caller.

4. The program storage device of claim 3 wherein the placing content into the mailslot by the caller comprises a remote procedure call.

5. The program storage device of claim 1 wherein the first process comprises a callee and wherein the accessing the mailslot by the first process to modify the contents of the mailslot further comprises placing results from the callee into the mailslot by a callee.

6. The program storage device of claim 1 further comprising notifying a second process to check the mailslot and releasing exclusive access by the first process to the mailslot.

7. The program storage device of claim 6 further comprising:
establishing for a second process exclusive access to the mailslot; and
accessing the mailslot by the second process to retrieve the contents of the mailslot to facilitate inter-process communication.

8. A mailbox for providing a two-step communication scheme, comprising a shared memory configured for establishing at least one mailslot, access to a mailslot being granted exclusively to a first process for modification of contents of the mailslot to facilitate inter-process communication.

9. The mailbox of claim 8 wherein the mailslot comprises a header having an operation code and a parameter region interpreted according to the operation code.

10. The mailbox of claim 8 wherein the first process comprises a caller, the caller accessing the mailslot by placing content into the mailslot.

11. The mailbox of claim 10 wherein the content comprises a remote procedure call.

12. The mailbox of claim 8 wherein the first process comprises a callee, the callee accessing the mailslot for placing into the mailslot.

13. The mailbox of claim 8 further being configured for exclusive access of the mailslot by a second process after the first process notifies the second process to check the mailslot and releases exclusive access to the mailslot.

14. A system, comprising:
a first process;
a second process;
a mailbox, disposed between the first and second process, the mailbox comprising a shared memory configured for establishing at least one mailslot, access to a mailslot being granted exclusively to the first process for modification of contents of the mailslot to facilitate inter-process communication.

15. The system of claim 8 wherein the mailslot comprises a header having an operation code and a parameter region interpreted according to the operation code.

16. The system of claim 8 wherein the first process comprises a caller, the caller accessing the mailslot by placing content into the mailslot.

17. The system of claim 10 wherein the content comprises a remote procedure call.

18. The system of claim 8 wherein the first process comprises a callee, the callee accessing the mailslot for placing into the mailslot.

19. The system of claim 8 wherein the mailbox is configured for exclusive access of the mailslot by the second process after the first process notifies the second process to check the mailslot and releases exclusive access to the mailslot.

20. A service level agreement (SLA) server, comprising:
a plurality of processes, the plurality of processes comprising a database manager for managing performance data, an application server for collecting performance data and providing a client interface for establishing service level agreements, a SLA core for analyzing data and controlling actions based on service level agreements and policy and a performance monitor daemon for communicating with remote I/O service gateways to collect data and send throttling requests; and
a shared memory forming a mailbox, the mailbox being used for a two-step communication scheme between a first process and a second process, the mailbox configured for establishing at least one mailslot, access to a mailslot being granted exclusively to a first process for modification of contents of the mailslot to facilitate inter-process communication.

21. The SLA server of claim 20 wherein the mailslot comprises a header having an operation code and a parameter region interpreted according to the operation code.

22. The SLA server of claim 20 wherein the first process comprises a caller, the caller accessing the mailslot by placing content into the mailslot.

23. The SLA server of claim 22 wherein the content comprises a remote procedure call.

24. The SLA server of claim 20 wherein the first process comprises a callee, the callee accessing the mailslot for placing into the mailslot.

25. The SLA server of claim 20 wherein the mailbox is configured for exclusive access of the mailslot by the second process after the first process notifies the second process to check the mailsiot and releases exclusive access to the mailslot.

26. A service level agreement (SLA) server, comprising:
a processor configured for providing a plurality of processes; and
memory configured for forming a mailbox, the mailbox being used for a two-step communication scheme between a first process and a second process;
wherein the processor establishes at least one mailslot in the mailbox and grants access to a mailslot exclusively to a first process for modification of contents of the mailslot to facilitate inter-process communication.

27. A method for providing a two-step communication scheme, comprising:
establishing for a first process exclusive access to a mailslot in a mailbox shared by a plurality of processes; and
accessing the mailslot by the first process to modify the contents of the mailslot to facilitate inter-process communication.

28. A mailbox for providing a two-step communication scheme, comprising a shared memory means configured for establishing at least one means for storing mail, access to a means for storing mail being granted exclusively to a first process means for modification of contents of the means for storing mail to facilitate inter-process communication.

29. A system, comprising:
first process means;
second process means;
mailbox means comprising a shared memory, disposed between the first and second process means, configured for establishing at least one means for storing mail, access to means for storing mail being granted exclusively to the first process means for modification of contents of the means for storing mail to facilitate inter-process communication.

30. A service level agreement (SLA) server, comprising:
plurality of process means, the plurality of process means comprising means for managing performance data in a database, application server means for collecting performance data and providing a client interface for establishing service level agreements, means for analyzing data and controlling actions based on service level agreements and policy and a means for communicating with remote I/O service gateways to collect data and send throttling requests; and
memory means forming a mailbox, the memory means being used in a two-step communication scheme between a first process means and a second process means, the memory means establishing at least one means for storing mail, access to means for storing mail being granted exclusively to a first process means for modification of contents of the means for storing mail to facilitate inter-process communication.
